(19) United States
(12) Patent Application Publication
(10) Pub. No.: US 2021/0141325 A1
(43) Pub. Date: May 13, 2021

(54) SILICONE SPONGE ROLLER FOR FIXING DEVICE AND ALSO HEAT FIXING DEVICE

(71) Applicant: KINYOSHA CO., LTD., Tokyo (JP)

(72) Inventors: Michiyoshi KUROSAWA, Kasama-shi (JP); Shigeto TSUDA, Tsukuba-shi (JP); Kyohei EBATA, Omitama-shi (JP)

(21) Appl. No.: 17/094,315

(22) Filed: Nov. 10, 2020

(30) Foreign Application Priority Data
Nov. 13, 2019 (JP) 2019-205399

(51) Int. Cl. G03G 15/20

(52) U.S. Cl. CPC G03G 15/2053; G03G 15/206

(57) ABSTRACT

A silicone sponge roller for a fixing device, includes a roller substrate, a silicone sponge layer formed on the roller substrate, and a surface layer including formed of a fluorocarbon resin formed on the silicone sponge layer. The silicone sponge layer is a foam including a silicone rubber and air bubbles formed from microballoons scattered in the silicone rubber. The silicone sponge layer includes air permeating through holes aligned along the axis direction of the roller substrate, opening to both end surfaces of the silicone sponge layer. The air bubbles exist in the periphery of the through holes, and at least a part thereof is positioned in the inner surface of the through hole.

### CROSS-REFERENCE TO RELATED APPLICATIONS

This application is based upon and claims the benefit of priority from prior Japanese Patent Application No. 2019-205399, filed November 13, 2019, the entire contents of which are incorporated herein by reference.

### BACKGROUND OF THE INVENTION

### 1. Field of the Invention

The present invention relates generally to a silicone sponge roller for a fixing device and also a heat fixing device.

### 2. Description of the Related Art

Electronphotographic image forming apparatus are, for example, a photocopier, printer, and facsimile. In a heat fixing device of an image forming apparatus, a sponge roller for a fixing device for the heat fixation of an unfixed image to a recording material such as a paper is used.

In recent years, as the image forming apparatus are made smaller and lighter, the roller for a fixing device used in the image forming apparatus is made smaller and lighter. Such a roller for a fixing device includes a roller substrate, sponge layer formed in the outer periphery of the roller substrate, and surface layer formed on the outer periphery of the sponge layer. Specifically, a silicone sponge which is excellent in the heat resistivity is preferred as a sponge layer of a sponge roller for a fixing device. The sponge roller for a fixing device can have a sufficient nip width required for the heat fixation since the hardness of the roller surface can be lowered, and have an advantage on excellent thermal insulation.

In general, heat of 150 to 200° C. is applied to the sponge roller for a fixing device for the heat fixation in the image forming apparatus. In a conventional sponge roller for a fixing device, when high heat is applied thereto, a material of the sponge layer is thermally expanded, and the air in the sponge layer is thermally expanded. Thus, the outer diameter of the sponge roller is greatly altered, and the nip width is greatly changed accordingly, which is a technical problem. Furthermore, in the conventional sponge roller for a fixing device is, when being used with the thermally expanded sponge layer, the hardness of the roller surface and the outer diameter are changed in an early stage and the durability is decreased, which is another technical problem.

Furthermore, when the air in the sponge layer is thermally expanded by heating, the pressure in air bubbles increases, and thus, the air in the air bubbles is diffused in the sponge layer to be moved to the outside of the roller. The air in the air bubbles is not easily released from the roller center part to the outside because there is a surface layer which does not easily pass the air. On the other hand, the air in the air bubbles is easily released to the outside from the both end surface parts of the roller. Thus, the outer diameter of the roller becomes uneven in the center part of the roller and the both ends of the roller, and paper wrinkle occurs in the heat fixation process.

Patent Literature 1 (JP 2870878 B) discloses a roller for fixing device. The roller for a fixing device includes a sponge layer covering a core metal and a plurality of through holes in the sponge layer parallel to the longitudinal direction of the core metal. Thus, the thermal expansion is suppressed, and the occurrence of the paper wrinkle in the heat fixation process is suppressed.

Patent Literature 2 (JP 3969942 B) discloses a pressure roller used in an image heat fixing device of an electrophotographic image forming apparatus. The pressure roller includes an elastic layer formed of a cured silicone rubber, and the elastic layer includes a large number of already-expanded microballoons scattered inside with open-cell air bubbles. In the pressure roller, the air bubbles in the elastic layer are open-cell, and thus, the air permeability of the elastic layer is improved, and the thermal expansion can be suppressed.

Patent Literature 3 (JP 2019-123844 A) discloses a sponge roller used in an image forming apparatus. The sponge roller includes a foam elastic layer. As a foaming agent, unexpanded microballoons and a chemical forming agent are used in the foam elastic layer, and thus, a high open-cell ratio is achieved. The sponge roller with the foam elastic layer having a high open-cell ratio, and thus, the air permeability of the foam elastic layer is improved, and the thermal expansion is suppressed.

### BRIEF SUMMARY OF THE INVENTION

However, the roller for a fixing device of Patent Literature 1 includes a skin layer formed of a rubber material on the inner surface of through holes, which hardens the periphery of the through holes. When a sponge layer is formed using a chemical foaming agent, which is a conventional foaming agent, gas components generated by the thermal decomposition of the chemical foaming agent are released to the outside through the inner surface of the through hole. As a result, the periphery of the through holes is not foamed evenly, and the skin layer is formed. If the roller for a fixing device is used under a highly compressed condition, damage of the sponge layer progresses from the skin layer in the periphery of the through holes in a relatively short time, and the durability decreases.

On the other hand, in a method of making a sponge layer open-cell as in Patent Literatures 2 and 3, the open-cell ratio of the sponge layer greatly changes depending on the hardness of a rubber material and a difference of viscosity, and the control thereof is very difficult. If the open-cell ratio of the sponge layer cannot be controlled to a constant, it may cause a case where the hardness of the surface of the roller and the outer diameter thereof change per production lot. Furthermore, in a method of making the sponge layer open-cell, addition of a specific open-cell agent and/or a specific treatment process to increase an open-cell ratio are required, and thus, costs for materials and process increase.

The present invention improves the air permeability of the sponge layer to suppress the thermal expansion and a change in the outer diameter, and presents a silicone sponge roller for a fixing device with high durability, and also a heat fixing device with the roller.

In order to solve the aforementioned problems, according to an embodiment, a silicone sponge roller for a fixing device includes: a roller substrate; a silicone sponge layer formed on the outer periphery of the roller substrate; and a surface layer made of a fluorocarbon resin formed on the outer periphery of the silicone sponge layer. The silicone sponge layer is a foam including a silicone rubber and a plurality of air bubble formed from microballoons scattered in the silicone rubber. The silicone sponge layer includes a plurality of through holes for air permeating aligned along the axis direction of the roller substrate, opening to both end surfaces of the silicone sponge layer. Air bubbles formed from the microballoons exist in the periphery of the through holes, and at least a part thereof is positioned in the inner surface of the through hole.

Furthermore, according to another embodiment, a heat fixing device includes the sponge roller for a fixing device.

With the sponge roller for a fixing device, the air permeability of the sponge layer is improved to suppress the thermal expansion and a change in the outer diameter, and thus, the paper wrinkle in the heat fixation and unevenness in the fixation can be suppressed. Furthermore, improved durability of the sponge roller for a fixing device of the present invention can be achieved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of an example of a silicone sponge roller for a fixing device.

FIG. 2 is a schematic cross-sectional view of a heat fixing device including the silicone sponge roller for a fixing device of FIG. 1 as a pressure roller.

FIG. 3 is a diagram illustrating an end surface of a silicone sponge layer manufactured in Example 1.

FIG. 4 is a photograph of a through hole of the silicone sponge layer of FIG. 3, in an enlarged manner.

FIG. 5 is a photograph of a through hole of a silicone sponge layer manufactured in Example 2, in an enlarged manner.

### DETAILED DESCRIPTION OF THE INVENTION

Hereinafter, a silicone sponge roller for a fixing device of embodiments will be explained in detail.

FIG. 1 is a perspective view of an example of the silicone sponge roller for a fixing device.

The silicone sponge roller 1 for a fixing device includes a roller substrate 11. The roller substrate 11 includes, for example, a cylindrical roller main body 11a and two axis parts 11b and 11b extending from both ends of the main body 11a. On the outer periphery of the main body 11a of the roller substrate 11, a silicone sponge layer 12 is formed. On the outer periphery of the silicone sponge layer 12, a surface layer 13 made of a fluorocarbon resin is formed. The silicone sponge layer 12 includes a plurality of air permeating through holes 14. The through holes 14 extend along the axis direction of the roller substrate 11, and open on the both end surfaces 12a and 12b of the silicone sponge layer 12. The through holes 14 are arranged at regular intervals in a ring shape along the circumferential direction of the main body 11a of the roller substrate 11. The through holes 14 each have a substantial ellipse shape.

The roller substrate 11 is formed of any high solidity material which is, for example, carbon FRP, or a metal material such as aluminum alloy, stainless steel, or iron. The material of the roller substrate 11 is, preferably, a metal material.

The axis parts 11b and 11b are used to support the both ends of the roller main body 11a and/or to engage with a driving part. The axis part 11b has an outer diameter and a length corresponding to the use thereof. The roller main body 11a and the axis parts 11b and 11b may be formed integrally or may be formed separately to be combined. The axis part 11b may be referred to as a journal, in general.

The silicone sponge layer 12 is a foam including a silicone rubber and air bubbles formed from a plurality of microballoons scattered in the silicone rubber. The microballoons are micro hollow spheres disposed evenly in the silicone rubber, and form the air bubbles of the silicone sponge layer 12. The air bubbles formed from scattered microballoons exist also in the periphery of the through holes 14, and at least a part of the air bubbles formed from the microballoons is positioned on the inner surface of the through holes 14. In the inner surface of the through holes 14 where the air bubbles formed from the microballoons are positioned, a skin layer formed of a silicone rubber is not formed, and fine roughness caused of the air bubbles formed from microballoons (cf. FIG. 4). The air bubbles formed from the microballoons may have a true sphere shape, or may have a spherical shape with slight distortion.

The microballoon is a micro hollow body formed by expanding a thermally expandable micro particle with heat. The thermally expandable micro particle includes an outer shell made of a thermoplastic and a foaming agent vaporized by heating. An average cell diameter of the air bubble formed from the microballoon is 20 to 300 μm, and preferably, between 30 and 200 μm.

The surface layer 13 is made of a fluorocarbon resin because of its excellent releasability and durability. The thickness of the surface layer 13 may be 15 to 100 μm. The surface layer 13 is formed, preferably, as a thin tubular shape because of its excellent durability.

The fluorocarbon resin is, preferably, tetrafluoroethylene-perfluoroalkylvinylether polymer (PFA). If the fluorocarbon resin is a PFA, adhesion of a toner or the like to the surface layer because of a long use, and cracks of the surface layer because of thermal deterioration can be suppressed, and the processability is excellent.

The surface layer 13 may be made of a conductive fluorocarbon resin or a semiconductive fluorocarbon resin to prevent the surface electrification. The conductive fluorocarbon resin and the semiconductive fluorocarbon resin are fluorocarbon resins to which the conductivity is achieved by adding a conductive material such as a carbon black to a fluorocarbon resin material with a high volume resistivity.

The material for the fluorocarbon resin is a commercially available one which is, for example, Teflon (registered trademark) PFA451HP-J, PFA951HP Plus, and PFA959HP Plus of Chemours-Mitsui Fluoroproducts Co., Ltd., and Neoflon (registered trademark) PFA AP-230 and AP-231 of Daikin Industries, LTD., and P-66P of AGC Inc.

Between the roller substrate 11 and the silicone sponge layer 12, and between the silicone sponge layer 12 and the surface layer 13 may be adhered to each other by an adhesive agent. The adhesive agent is, since the silicone sponge roller for a fixing device is used under a high temperature, a silicone rubber adhesive agent, preferably. The silicone rubber adhesive agent is a room temperature cured type (condensation reaction type) silicone adhesive agent or a heat cured type (addition reaction type) silicone adhesive agent. The heat cured type silicone adhesive agent has a shorter cure time and a stable adhesive force, and thus, it is used preferably as the adhesive agent of the present invention.

In some embodiments, it is desired that, in a cross-section of the silicone sponge layer 12 cut perpendicularly with respect to the axis direction of the roller substrate 11, the total cross-section area of the through holes 14 occupies 4.5% or more with respect to a cross-section area of the silicone sponge layer 12.

If the above ratio is below 4.5%, there is a possibility that the air permeability of the silicone sponge layer 12 becomes insufficient and the thermal expansion is not sufficiently suppressed, which is not preferable. The total cross-section area of the through holes 14 occupies, preferably, between 4.5 and 20% of the cross-section area of the silicone sponge layer 12. If the above ratio is above 20%, there is a possibility that the strength of the silicone sponge layer decreases, and the durability thereof decreases, which is not preferable.

Now, the cross-section area of each through hole 14 is measured by a microscopic polygonal area measurement. The total cross-section area of the through holes 14 is calculated as a sum of the cross-section areas of each through hole 14. The cross-section area of the silicon sponge layer 12 is calculated from the outer diameter of the silicon sponge layer and the outer diameter of the roller substrate. The above ratio is calculated from the calculated value.

In some embodiments, an open-cell ratio of the silicone sponge layer 12 is, preferably, 10% or less.

The open-cell ratio is measured as follows.

A sponge sample piece is cut from a silicone sponge layer. Then, a weight (W1) of the cut piece of the sponge sample is measured, and density (D1) is calculated. Then, density (D2) of the silicone component which is a base material of the silicone sponge layer after mixing is measured. Then, the sponge sample piece is put in a vessel with water, and the sponge sample piece is completely sunk in water. Then, the vessel is placed in a decompressor to be decompressed at −0.0975 MPa for five minutes such that the sponge sample piece absorbs water. Then, the vessel is placed in a normal pressure environment for one minute. Then, the sponge sample piece is taken out of the vessel, water on the surface is removed by a non-woven cloth, and the weight (W2) of the water-absorbing sample piece is measured. The open-cell ratio of the sponge sample piece is calculated from the following formula.

Open-cell ratio [%]=100×(D1×(W2−W1)/W1)/(1−D1/D2)

In some embodiments, the silicone sponge roller 1 for a fixing device exerts, preferably, when being placed in a decompressor to start decompression to −0.095 MPa and ten minutes passes after a time when −0.095 MPa is marked, a decompression expansion ratio measured at that time is 50% or less as compared to a case where a silicone sponge roller for a fixing device including no through holes therein is used.

If the decompression expansion ratio is above 50% as compared to a case where the silicone sponge roller for a fixing device including no through holes therein, there is a possibility that the air permeability of the silicone sponge layer cannot be sufficient, and the thermal expansion cannot be suppressed sufficiently, which is not preferable.

The decompression expansion ratio is measured as follows.

The sample roller to be measured (silicone sponge roller for a fixing device) is placed in a decompressor while the both ends (axis parts) thereof are supported. Then, the decompression of the decompressor is started, and a time when the internal pressure reaches −0.095 MPa is set as zero, and furthermore, the decompression is continued to measure a decompression expansion amount based on a thickness change of the silicone sponge layer after ten minutes. A dial gage is brought contact with the center part of the sample roller in the decompressor, and a change between the outer diameter before decompression, and the outer diameter at ten minutes after the internal pressure reaches −0.095 MPa is a decompression expansion amount. The thickness of the silicone sponge layer before the decompression is calculated by measuring the outer diameter of the center part of the sample roller before the decompression, and subtracting the thickness of the roller substrate and the surface layer from the measured outer diameter. The decompression expansion ratio is calculated from the following formula.

Decompression expansion ratio [%]=Decompression expansion amount [mm] after ten minutes/thickness of silicone sponge layer before decompression [mm]×100

In some embodiments, the silicone sponge roller for a fixing device has an Asker C hardness of the surface thereof is 35 or more and 70 or less, preferably. Furthermore, the Asker C hardness of the silicone sponge layer is 15 or more and 60 or less, preferably. The Asker C hardness is measured with an Asker rubber durometer type C (Kobunshi Keiki Co., Ltd.) conforming to JIS K7312. In such a structure, when the silicone sponge roller for a fixing device is used as a pressure roller of the heat fixing device, a suitable fixation nip can be formed in the heat fixation process, which is preferable.

In the silicone sponge roller for a fixing device according to an embodiment, with the aforementioned structure, when air bubbles formed from microballoons inside the sponge layer are thermally expanded by heating, the air inside the air bubbles scatters in the periphery of the through holes via adjacent air bubbles. At that time, in the silicone sponge roller for a fixing device, the air bubbles formed from microballoons exist in the periphery of the through holes, and at least a part thereof is positioned on the inner surface of the through holes 14, and thus, the air inside the air bubbles easily scatters to the through holes 14 via the air bubbles formed from the microballoons. Then, the air scattered to the through holes is released to the outside in the both end surfaces of the silicone sponge roller for a fixing device. As a result, in the sponge roller 1, the air permeability of the silicone sponge layer 12 is improved, and the thermal expansion can be suppressed, and a change in the outer diameter can be suppressed. Furthermore, the silicone sponge roller for a fixing device suppresses the thermal expansion, and thus, a change to the hardness of the roller surface and the outer diameter according to the thermal expansion can be suppressed, and the high durability can be achieved.

Furthermore, in the sponge roller 1 of the embodiment, the air bubbles formed from microballoons exist in the periphery of the through holes 14, and at least a part thereof is positioned in the inner surface of the through holes 14. Thus, in the sponge roller 1, sufficient flexibility can be achieved in the proximity of the inner peripheral surface of the through holes. As a result, the sponge roller 1 can suppress a damage to the silicone sponge layer 12 even if it is used in a high compression condition, and high durability can be achieved.

Note that the sponge roller 1 of the embodiment can achieve the aforementioned effects without using a conventional method of making a silicone sponge layer open-cell. In the conventional open-cell method, as described above, the control of the air permeability of the silicone sponge layer is difficult, and the production costs are increased.

Note that the shape, number, and arrangement of the though holes are not limited to the above-mentioned examples. The cross-sectional shape of the through holes is, for example, a triangle, or other polygonal shape. The cross-sectional shapes of the through holes may be the same or different. Furthermore, the through holes may not extend linearly as long as they extend along the axis direction of the roller substrate, and may extend helically. The through holes are arranged at regular intervals in a single cylinder shape in the above example; however, it is not limited thereto, and may be arranged in a double or more cylindrical shape, or may not be arranged at regular intervals in a cylindrical shape. If the through holes are arranged at regular intervals in a cylindrical shape, the air permeability of the silicone sponge layer is even, which is preferable. Furthermore, the through holes are, preferably, positioned in the roller substrate side from the half position of the thickness of the silicone sponge layer to suppress the influence to the roller surface.

Hereinafter, a manufacturing method of the silicone sponge roller for a fixing device of the embodiment will be explained. The silicone sponge roller 1 for a fixing device is manufactured as follows.

Initially, millable type silicone rubber base material and microballoons are composed in a desired ratio, an additive agent is added and mixed, and a silicone rubber composition is prepared.

Then, with an extrusion device, the silicone rubber composition is continuously extruded to an unvulcanized silicone rubber tube. Here, in a die of the extrusion device, a plurality of pillar-shaped pins corresponding to the shape and the number of the through holes are provided. Thus, in the unvulcanized silicone rubber tube extruded, a plurality of pillar-shaped through holes are formed continuously.

Then, the unvulcanized silicone rubber tube is heated in a continuous furnace to be vulcanized and foamed, and the silicone sponge tube is prepared. Furthermore, the silicone sponge tube is entirely foamed by the air bubbles formed from microballoons scattered to the periphery of the through holes. As a result, at least a part of the air bubbles formed from microballoons is positioned in the inner surface of the through holes, and thus, fine unevenness is formed. Then, the silicone sponge tube is cut to a desired length.

Then, the axis parts are inserted to both ends, and a roller substrate including a cylindrical roller main body with desired length and diameter is prepared. Then, in the cut silicone sponge tube, the roller substrate to which an adhesive agent is applied is inserted, and the adhesive agent is cured. Thus, a silicone sponge layer is formed on the outer peripheral surface of the roller main body of the roller substrate.

Then, the silicone sponge layer is ground by a grinder to be adjusted to a desired size.

Separately, the fluorocarbon resin is formed as a tubular shape and cut to a desired length to prepare a fluorocarbon resin tube. Then, in the fluorocarbon resin tube, the roller in which the silicone sponge layer with an adhesive agent applied preliminarily on the outer peripheral surface is inserted, and the adhesive agent is cured. Thus, a surface layer formed of a fluorocarbon resin is formed on the outer peripheral surface of the silicone sponge layer.

Through the above process, the silicone sponge roller for a fixing device of the embodiment is manufactured.

The silicone rubber base material is, preferably, a millable type silicone rubber. The millable type silicone rubber is, in a pre-cured condition, similar to a natural rubber or an unvulcanized rubber of a synthetic rubber, and is a silicone rubber compound which becomes flexible by a mixing mill or a closed-type mixer. The millable type silicone rubber is a silicone rubber compound at least containing polyorganosiloxane with a polymerization degree of 100 or more and a reinforcing silica filler. Polyorganosiloxane of the millable type silicone rubber has a polymerization degree of 3000 to 10000, preferably. The reinforcing silica filler is, for example, silica BET ratio surface area of which is 50 m²/g or more. The reinforcing silica filler is contained 10 to 100 mass parts with respect to the 100 mass parts of polyorganosiloxane, preferably, the reinforcing silica filler is contained 10 to 70 mass parts, or 20 to 50 mass parts. The millable type silicone rubber is preferred since the aforementioned formation of the silicone sponge tube by the extrusion is easily performable.

Millable type silicone rubber is a commercially available one which is, for example, KE551-U, KE561-U, KE571-U, KE153-U, KE174-U, KE1551-U, KE1571-U, and KE904-FU of Shin-Etsu Chemical Co., Ltd., RBB-2070 series, SE1185U, SE1186U, and SE1187U of Dow Toray Co., Ltd., and ELASTOSIL EL3530, EL3630, and EL3730 of Wacker Asahikasei Silicone Co., Ltd.

The microballoon may be an unexpanded microballoon or an expanded microballoon, and is, preferably, an unexpanded microballoon. The unexpanded microballoon is commercially available one which is, for example, Matsumoto microsphere (registered trademark) F series, and FN series of Matsumoto Yushi-Seiyaku Co., Ltd., and Expancel (registered trademark) unexpanded grade WU type and DU type of Expancel. If the expanded microballoon is used, a high pressure is applied to the expanded microballoon in the mixing process of the silicone rubber component, and the micro hollow structure may possibly be squished.

The silicone rubber component may contain a general additive agent as an additive agent for silicon rubber. The additive agent may be, for example, a vulcanizing agent, vulcanizing aid agent, antioxidant agent, process aid agent, filler, color dye, conductivity applying agent, heat resistive applying agent, and heat conductivity applying agent.

The vulcanizing agent is a commercially available vulcanizing agent for a silicone rubber. The vulcanizing agent is for peroxide vulcanization or for addition vulcanization. The silicone sponge layer is, by adjusting a vulcanizing speed, a cell diameter and density of air bubbles formed from microballoons therein can be adjusted.

The vulcanizing agent for the peroxide vulcanization is, for example, peroxide such as benzoyl peroxide, dicumyl peroxide, 2,5-dimetyl-2,5-bis (t-butylperoxy) hexane, and paramethyl benzoyl peroxide. With the vulcanizing agent, by mixing two types of more peroxides, the vulcanizing speed of the silicone sponge layer can be adjusted.

The vulcanizing agent for addition vulcanization is one containing platinum catalyst, hydrogen group containing organopolysiloxane, and reaction controlling agent. The vulcanizing speed of the silicone sponge layer is more easily adjusted with the vulcanizing agent for addition vulcanization by changing the component of the vulcanizing agent as compared to the vulcanizing agent for peroxide vulcanization.

Note that the silicone rubber component has, preferably, high elasticity in consideration of maintenance of the shape of through holes in a sponge tube manufacturing process, and a silicone rubber base material with adjusted moisture contained in a filler or the like is, preferably, used to suppress unevenness in the foaming in a high temperature vulcanizing process.

In some embodiments, at any stage after the formation of the silicone sponge layer, and a process to break the outer shell of the microballoons therein, formed of a thermoplastic is, preferably, performed. With a process to break the outer shell, a change to the hardness of the roller surface and the outer diameter in the initial state of the sponge roller can be suppressed.

The method of breaking the outer shell of the microballoons is, for example, heating the silicone sponge layer at a heating temperature in the vulcanizing or more, pressing a metal roller surface of which is heated to a high temperature onto the silicone sponge layer (thermal compression process), and pressing the silicone sponge layer at a normal temperature. The method of breaking the outer shell of the microballoons is, preferably, the thermal compression process since the deterioration of the silicone sponge layer is small, and the process is performable in a short time.

In some embodiments, the surface layer 13 is, preferably, subjected to a treatment to ease adhesion in the inner peripheral surface in an adhesion agent since a fluorocarbon resin is generally difficult to be adhered. The treatment is, for example, a method of applying a solution based on ammonia water in which a metallic sodium is dissolved, and a method of etching process by excimer laser.

Note that the above-mentioned manufacturing method of the silicone sponge roller for a fixing device of the embodiment is an example. For example, a process of forming the silicone sponge layer may be as follows; however, the above-mentioned method is preferred since the shape of the through holes is stable.

In one method, initially, a primer is applied to the outer peripheral surface of the roller substrate. Then, using the extrusion device, the roller substrate and the silicone rubber component are integrally extruded, and the outer periphery of the roller substrate is covered with a silicone rubber component. Here, pins are provided with the die of the extrusion device, and through holes are formed in the covered silicone rubber component. Then, the unvulcanized silicone rubber component is vulcanized and foamed to prepare a silicone sponge layer. Then, the surface of the silicone sponge layer is arbitrarily ground.

In another method, initially, a primer is applied to the outer peripheral surface of the roller substrate. Then, using the extrusion device, the roller substrate and the silicone rubber component are integrally extruded, and the outer periphery of the roller substrate is covered with a silicone rubber component. Here, pins are provided with the die of the extrusion device, and through holes are formed in the covered silicone rubber component. Then, the roller substrate with the silicone rubber component formed on the outer peripheral surface is placed in a die having a constant inner diameter, and the unvulcanized silicone rubber component is vulcanized and foamed in the die to prepare a silicone sponge layer on the outer peripheral surface of the roller substrate. In this method, grinding of the surface of the silicone rubber sponge layer is not required.

Hereinafter, an example of use of the silicone sponge roller for a fixing device will be explained.

The silicone sponge roller for a fixing device of the embodiment is not limited specifically as long as it is a silicone sponge roller for a fixing device used in a heat fixing device, and for example, used as a pressure roller, fixation roller, or heating roller.

FIG. 2 is a schematic cross-sectional view of a heat fixing device including the silicone sponge roller 1 for a fixing device of FIG. 1 as a pressure roller. FIG. 2 indicates a process of heat fixation of an unfixed image 32 on a recording material 3 such as paper 31 by the heat fixing device.

The heat fixing device includes a pressure roller 1 and a heat fixation member 2. The heat fixation member 2 includes a fixation belt 21, belt guide member 22, and heater 23. The belt guide member 22 has a substantial arc/gutter shaped cross-section, and includes the heater 23 inside thereof.

The fixation belt 21 has, for example, a cylindrical shape with a thin heat resistive resin such as polyimide covered with a surface layer such as fluoride resin. The fixation belt 21 is loosely fit on the belt guide member 22 including the heater 23 inside. The fixation belt 21 is heated by the heater 23. The pressure roller 1 is pressed to the belt guide member 22 with the fixation belt 21 interposed therebetween, and forms a fixation nip by elastic change of the silicone sponge layer 12. With the rotation drive of the pressure roller 1, the fixation belt 21 rotates in cooperation. The heat fixing device conveys a recording material 3 such as paper 31 having an unfixed image 32 thereon between the fixation nips for heat fixation.

In the heat fixing device of the present embodiment, with the silicone sponge roller 1 for a fixing device, a change to the fixation nip caused by the heat expansion or the like of the pressure roller can be suppressed, and the heat fixation can be performed stably. The heat fixing device of the embodiment includes the silicone sponge roller for a fixing device with high durability, costs for exchange can be suppressed.

Note that the heat fixing device of the embodiment is sufficient as long as it has the sponge roller for a fixing device of the embodiment, and other structures are not limited. The heat fixing device of the embodiment may include the sponge roller for a fixing device of the embodiment as a different type roller such as a fixation roller or a heating roller.

Hereinafter, the silicone sponge roller for a fixing device of the embodiment will be further explained with reference to Examples and Comparative Examples.

### EXAMPLE 1

Initially, a silicone rubber component was prepared.

The silicone rubber component contained 100 mass parts of KE904-FU (product name) of Shin-Etsu Chemical Co., Ltd., as a millable type silicone rubber, 0.3 mass parts of C-23N (product name) (containing 50% of paramethylbenzoylperoxide) and 2 mass parts of C-3 (product name) (containing 50% of paramethylbenzoylperoxide) of Shin-Etsu Chemical Co., Ltd., which are vulcanizing agents for peroxide vulcanization as a vulcanizing agent, 1.5 mass parts of Matsumoto Microsphere (registered trademark) FN-100MD (product name) of Matsumoto Yushi-Seiyaku Co., Ltd., as unexpanded microballoons, and 0.5 mass parts of KE-COLOR BR (product name) (containing 50% of iron oxide) of Shin-Etsu Chemical Co., Ltd., as a coloring agent.

Then, the above-mentioned component materials were mixed to prepare a silicone rubber mixture component.

Then, the silicone mixture component was continuously extruded into an unvulcanized silicone rubber tube using an extrusion device. Here, with 18 pillar-shaped pins provided with a die of the extrusion device, 18 circular through holes are continuously formed in the unvulcanized silicone rubber tube.

Then, the unvulcanized silicone rubber tube was heated for eight minutes at 280° C. in a continuous heating furnace for vulcanizing and foaming the tube. Thereby, a foamed silicone rubber tube with an inner diameter of 14.5 mm and an outer diameter 28 mm was prepared. Then, the foamed silicone rubber tube was cut into a length of 280 mm.

Then, the cut foamed silicone rubber tube was heated for four hours at 200° C. in a heating furnace to remove low molecule substances and decomposition products, and a silicone sponge tube was prepared. Then, a metal roller substrate including a roller main body having axis parts at both ends with an outer diameter 15 mm and a length of 230 mm was prepared. Then, on the outer peripheral surface of the roller main body of the roller substrate, a thermal cured silicone adhesive agent was applied with a thickness of 200 μm. The adhesive agent was X-32-2136 (product name) of Shin-Etsu Chemical Co., Ltd.

Then, the roller substrate including the roller main body with the adhesive agent applied thereon was inserted into the prepared silicone sponge, and the adhesive agent was cured for two hours at 150° C. in a heating furnace. Then, after cooling down, the silicone sponge surface adhered to the outer peripheral surface of the roller main body was ground. Thereby, the silicone sponge layer was prepared on the outer peripheral surface of the roller main body. The formed silicone sponge layer included an outer diameter of 25 mm and a surface Asker C type hardness of 46.

Then, a thermal compression process was performed to the formed silicone sponge layer, and the outer shell of the thermal elastic resin of the microballoons therein was broken. The thermal compression process was performed by pressing a metal roller with a surface temperature heated to 180° C. onto the silicone sponge layer for thirty seconds such that a compression rate of a thickness of the sponge layer becomes 40%. The silicone sponge layer after the thermal compression process exerted Asker C type hardness of 39 in its surface. Note that an open-cell ratio of the silicone sponge layer was not changed before and after the thermal compression process.

Then, a conductive fluorocarbon resin tube with an inner diameter 24 mm, length of 280 mm, and thickness 50 μm was prepared. The conductive fluorocarbon resin tube was Neoflon (registered trademark) PFA AP-230ASL of Daikin Industries, LTD.

Then, a thermal cured silicone adhesive agent was applied on the outer peripheral surface of the silicone sponge layer after the thermal compression process with a thickness of 30 μm. The adhesive agent was X-32-2136 (product name) of Shin-Etsu Chemical Co., Ltd. Then, the roller substrate to which the adhesive agent was applied was inserted into the fluorocarbon resin tube, and the adhesive agent was cured for four hours at 120° C. in a heating furnace. Thereby, a silicone sponge roller for a fixing device of Example 1 was prepared.

The silicone sponge layer of Example 1 indicated an average cell diameter of air bubbles formed from microballoons inside thereof of 113 μm, density of 0.58 g/cm³, and open-cell ratio of 7.5%. The roller of Example 1 indicated an average value of surface Asker C hardness after the surface layer was formed of 55.7.

FIG. 3 illustrates an end surface of the silicone sponge layer 12 prepared in Example 1. The silicone sponge layer 12 includes 18 air permeating through holes 14. 18 through holes 14 are arranged at regular intervals in a ring shape along the peripheral direction of the silicone sponge layer. 18 through holes 14 each include a substantial ellipse shape, and are arranged symmetrically with respect to the center point of the end surface.

FIG. 4 is a photograph of a through hole of the silicone sponge layer of FIG. 3, illustrated in an enlarged manner. The photograph of enlarged-image was captured by AS-1000 microscope of Microadvance Corp. The through hole was, through polygonal area measurement of the microscope, a substantial ellipse shape with a major axis of approximately 1.5 mm and a minor axis of approximately 0.72 mm, and a cross-section area of 0.85 mm². The total cross-section area of 18 through holes was 4.9% with respect to the cross-section area of the silicone sponge layer. From FIG. 4, it is understood that the silicone sponge layer is evenly foamed to the proximity of the through holes, air bubbles formed from microballoons position in the inner surface, and fine unevenness is formed by the exposure. That is, on the inner surface of the through holes, a skin layer formed of a rubber material is almost completely removed (a thickness of the skin layer is not measurable).

### EXAMPLE 2

In Example 2, a roller was prepared in the same method as Example 1 except that a total cross-section area of through holes occupied 7.2% with respect to a cross-section area of a silicone sponge layer. The total cross-section area of through holes was changed such that a shape of a plurality of pillar-shaped pins provided with a die of an extrusion device was slightly greater than those of Example 1.

### EXAMPLE 3

In Example 3, a roller was prepared in the same method as Example 1 except that a total cross-section area of through holes occupied 14.2% with respect to a cross-section area of a silicone sponge layer. The total cross-section area of through holes was changed such that a shape of a plurality of pillar-shaped pins provided with a die of an extrusion device was slightly greater than those of Example 1.

### EXAMPLE 4

In Example 4, a roller was prepared in the same method as Example 1 except that 2.3 mass parts of FN-80GSD of Matsumoto Yushi-Seiyaku Co., Ltd., as unexpanded microballloons was added in a silicone rubber component. The silicone sponge layer of Example 4 indicated an average cell diameter of air bubbles formed from microballoons inside thereof of 42 μm, and an open-cell ratio of 3.2%. The roller of Example 4 indicated that the total cross-section area of the through holes occupied 6.1% with respect to the cross-section area of the silicone sponge layer.

### COMPARATIVE EXAMPLE 1

In Comparative Example 1, a roller was prepared as in Example 1 except that through holes are not provided with a silicone sponge layer.

### COMPARATIVE EXAMPLE 2

In Comparative Example 2, materials and combination of a silicone rubber component were changed to be different from those of Example 1.

The silicone rubber component contained 100 mass parts of the same material as in Example 1 as a base rubber material, 0.7 mass parts of C-23N and 2 mass parts of C-3 as vulcanizing agents, 1.4 mass parts of AIBN (product name) of Otsuka Chemical Co., Ltd., which is a chemical foaming agent as a foaming agent instead of unexpanded microballoon, and 0.5 mass parts of the same material as in Example 1 as a coloring agent.

Then, the silicone rubber component was used to prepare a silicone sponge tube in the same method as in Example 1. The silicone sponge tube had an inner diameter of 14.5 mm and an outer diameter of 28 mm. The silicone sponge tube includes 18 ellipse-shaped through holes with a major axis of 1.5 mm and a minor axis of 0.8 mm. Then, using the silicone sponge tube, a roller of Comparative Example 2 was prepared in the same method as Example 1 except for not performing the thermal compression process.

The silicone sponge layer of Comparative Example 2 indicated an average cell diameter of air bubbles inside thereof of 210 μm, and an open-cell ratio of 8.2%. In the roller of Comparative Example 2, the total cross-section area of through holes occupied 5.4% with respect to the cross-section area of the silicone sponge layer.

FIG. 5 is a photograph of a through hole of the silicone sponge layer manufactured in Comparative Example 2, in an enlarged manner. The photograph of enlarged-image was captured by the same microscope as in FIG. 4. From FIG. 5, it is understood that the silicone sponge layer is not evenly foamed to the proximity of the through holes, and a skin layer formed of a rubber material with an average thickness 155 μm is formed in the inner surface thereof. The thickness of the skin layer of the inner surface of the through holes was calculated by the microscope as an average value of thicknesses at optional six points on a distance between the inner surface of the through holes to a gap.

As to Examples 1 to 4 and Comparative Examples 1 and 2, Table 1 below shows mixture of used silicone rubber components, characteristics of silicone sponge layers, and measurement results of aforementioned decompression expansion ratios. Characteristics of the silicone sponge layers are A/NA of thermal compression process, Asker C hardness, density, average cell diameter air bubbles, open-cell ratio, N/NA of through hole, cross-section area ratio of through holes/silicone sponge layer, and thickness of skin layer.

TABLE 1

| | | | | | | | Comparative | |
|---|---|---|---|---|---|---|---|---|
| | | | Example | | | | Example | |
| | | | 1 | 2 | 3 | 4 | 1 | 2 |
| Composition | Millable type | Mass | 100 | 100 | 100 | 100 | 100 | 100 |
| | silicone rubber | parts | | | | | | |
| | KE-904FU | | | | | | | |
| | Vulcanizing | Mass | 0.3 | 0.3 | 0.3 | 0.3 | 0.3 | 0.7 |
| | agent C-23N | parts | | | | | | |
| | Vulcanizing | Mass | 2 | 2 | 2 | 2 | 2 | 2 |
| | agent C-3 | parts | | | | | | |
| | Unexpanded | Mass | 1.5 | 1.5 | 1.5 | — | 1.5 | — |
| | microballoon | parts | | | | | | |
| | FN-100MD | | | | | | | |
| | Unexpanded | Mass | — | — | — | 2.3 | — | — |
| | microballoon | parts | | | | | | |
| | FN-80GSD | | | | | | | |
| | Chemical | Mass | — | — | — | — | — | 1.4 |
| | foaming | parts | | | | | | |
| | agent AIBN | | | | | | | |
| | Coloring agent | Mass | 0.5 | 0.5 | 0.5 | 0.5 | 0.5 | 0.5 |
| | KE-COLOR-BR | parts | | | | | | |

| | | | | | | | Comparative | |
|---|---|---|---|---|---|---|---|---|
| | | | Example | | | | Example | |
| | | | 1 | 2 | 3 | 4 | 1 | 2 |
| Silicone | Thermal | | A | A | A | A | A | N/A |
| sponge | compression | | | | | | | |
| layer | process | | | | | | | |
| | Hardness | Asker | 39 | 38 | 36 | 38 | 40 | 39 |
| | | C | | | | | | |
| | Density | g/cm³ | 0.58 | 0.58 | 0.57 | 0.59 | 0.58 | 0.58 |
| | Average cell | μm | 113 | 115 | 116 | 42 | 115 | 210 |
| | diameter | | | | | | | |
| | Open-cell ratio | % | 7.5 | 7.5 | 7.6 | 3.2 | 7.6 | 8.2 |
| | Through hole | | A | A | A | A | N/A | A |
| | Through holes/ | % | 4.9 | 7.2 | 14.2 | 6.1 | — | 5.4 |
| | silicone | | | | | | | |
| | sponge layer | | | | | | | |
| | cross-section | | | | | | | |
| | area ratio | | | | | | | |
| | Thickness of | μm | Unmeasur- | Unmeasur- | Unmeasur- | Unmeasur- | — | 155 |
| | skin layer | | able | able | able | able | | |
| | Decompression | % | 1.2 | 1.0 | 1.0 | 2.0 | 3.0 | 3.0 |
| | expansion ratio | | | | | | | |

Performance was evaluated with respect to each of sponge rollers of Examples 1 to 4 and Comparative Examples 1 and 2 used as a pressure roller (durability test). Each sponge roller was incorporated into a heat fixing device as a pressure roller. The heat fixing device includes the pressure roller and a heating roller as a heating fixation member to form a fixation nip. The heating roller includes a surface layer formed of a fluorocarbon resin, and a heater therein. The heating roller has an outer diameter of 40 mm, and is heated to 180° C. surface temperature in a use time. The heating roller is rotated in cooperation with the rotation of the pressure roller.

Initially, the pressure roller is pressed to the heating roller such that the thickness of the silicone sponge layer was compressed by 30% (initial compression). Then, while the weight of the initial compression was maintained, a pressure fixing device was operated at the same number of rotations as when 100,000 and 300,000 A4 copy papers were feed. Then, a change to hardness and outer diameter from the initial state was measured with respect to the pressure roller after the operation.

Similarly, the pressure roller was pressed such that the thickness of the silicone sponge layer was compressed by 40%, and the same test was performed. In the durability test with 30% compression, at the time when feeding 300,000 papers, if a change to the hardness is 3 or less and a change to the outer diameter is 0.1 mm or less as compared to the initial compression time, the test is considered as a pass. On the other hand, in the durability test with 40% compression, at the time when feeding 300,000 papers, if breaking of the pressure roller does not occur, the test is considered as a pass. The results are shown in Table 2 below.

TABLE 2

| | | | Example | | | | Comparative Example | |
|---|---|---|---|---|---|---|---|---|
| | | | 1 | 2 | 3 | 4 | 1 | 2 |
| Durability | Initial hardness | Asker | 55.7 | 55.1 | 53.6 | 55.3 | 57.2 | 56.7 |
| test 30% | average value | C | | | | | | |
| compression | Average value of | Asker | 54.1 | 54.0 | 52.2 | 53.9 | 54.8 | 52.6 |
| | hardness | C | | | | | | |
| | after feeding | | | | | | | |
| | 100,000 papers | | | | | | | |
| | Average value of | Asker | 53.3 | 52.7 | 51.9 | 53.5 | 53.1 | 50.2 |
| | hardness | C | | | | | | |
| | after feeding | | | | | | | |
| | 300,000 papers | | | | | | | |
| | Change to | Asker | −2.4 | −2.4 | −1.7 | −1.8 | −4.1 | −6.5 |
| | hardness | C | | | | | | |
| | Initial outer | mm | 24.985 | 24.961 | 24.924 | 24.929 | 24.964 | 24.962 |
| | diameter | | | | | | | |
| | average value | | | | | | | |
| | Average value of | mm | 24.969 | 24.948 | 24.926 | 24.898 | 24.926 | 24.983 |
| | outer diameter | | | | | | | |
| | after feeding | | | | | | | |
| | 100,000 papers | | | | | | | |
| | Average value of | mm | 24.972 | 24.952 | 24.914 | 24.903 | 24.920 | 24.997 |
| | outer diameter | | | | | | | |
| | after feeding | | | | | | | |
| | 300,000 papers | | | | | | | |
| | Change to | mm | −0.013 | −0.009 | −0.010 | −0.026 | −0.044 | 0.035 |
| | outer diameter | | | | | | | |

| | | | Example | | | | Comparative Example | |
|---|---|---|---|---|---|---|---|---|
| | | | 1 | 2 | 3 | 4 | 1 | 2 |
| Durability | Initial hardness | Asker | 55.6 | 55.3 | 54.1 | 55.6 | 57.1 | 56.2 |
| test 40% | average value | C | | | | | | |
| compression | Average value of | Asker | 51.3 | 51.2 | 51.3 | 51.8 | 51.1 | Broken at |
| | hardness | C | | | | | | approximately |
| | after feeding | | | | | | | 100,000 |
| | 100,000 papers | | | | | | | |
| | Average value of | Asker | 49.6 | 49.2 | 49.0 | 50.1 | Broken at | — |
| | hardness | C | | | | | approximately | |
| | after feeding | | | | | | 200,000 | |
| | 300,000 papers | | | | | | | |
| | Change to | Asker | −6.0 | −6.1 | −5.1 | −5.5 | — | — |
| | hardness | C | | | | | | |
| | Initial outer | mm | 24.993 | 24.972 | 24.931 | 24.926 | 24.951 | 24.961 |
| | diameter | | | | | | | |
| | average value | | | | | | | |
| | Average value of | mm | 24.953 | 24.942 | 24.903 | 24.889 | 24.953 | Broken at |
| | outer diameter | | | | | | | approximately |
| | after feeding | | | | | | | 100,000 |
| | 100,000 papers | | | | | | | |
| | Average value of | mm | 24.914 | 24.899 | 24.832 | 24.865 | Broken at | — |
| | outer diameter | | | | | | approximately | |
| | after feeding | | | | | | 200,000 | |
| | 300,000 papers | | | | | | | |
| | Change to | mm | −0.079 | −0.073 | −0.099 | −0.061 | — | — |
| | outer diameter | | | | | | | |

As in Table 2, the sponge rollers of Examples 1 to 4 satisfied the target value in both of the durability tents with 30% compression and 40% compression. Furthermore, as in Table 1, the sponge rollers of Examples 1 to 4 indicated the decompression expansion ratio of 2% or less which is a low value. Furthermore, the sponge rollers of Examples 1 to 3 indicate the decompression expansion ratio (1.0 to 1.2%) which is 50% or less as compared to that of a silicone sponge roller for a fixing device without through holes (decompression expansion ratio 3% of Comparative Example 1). Furthermore, as in Table 1, the thickness of the skin layer of through holes of Examples 1 to 3 was as thin as nearly unmeasurable, and air bubbles formed from microballoons were positioned in the inner peripheral surface of the through holes.

From the above results, it can be evaluated that the sponge rollers of Examples 1 to 4 can improve the air permeability of the silicone sponge layer to suppress a change to the outer diameter thereof, and exerts high durability. This is because the sponge rollers of Examples 1 to 4 have the structure of the present invention.

Furthermore, as in Table 1, the sponge rollers of Examples 1 to 4 include the silicone sponge layer open-cell ratio of which is 10% or less, which is not open-cell. From the above results, with the present invention, the air permeability of the silicone sponge layer can be improved without using a conventional method of making a silicone sponge layer open-cell, which is difficult to control and with higher production costs.

In contrast, as in Table 2, the sponge rollers of Comparative Examples 1 and 2 does not satisfy the target value of a change to hardness in the durability test of 30% compression, and the hardness thereof significantly decreased when feeding approximately 300,000 papers. Furthermore, the sponge roller of Comparative Example 1 showed, in the durability test of 40% compression, breaking between the roller substrate and the silicone sponge layer when feeding approximately 200,000 papers, and thus, the test was stopped. Furthermore, the sponge roller of Comparative Example 2 showed, in the durability test of 40% compression, breaking in the proximity of through holes of the silicone sponge layer when feeding approximately 100,000 papers, and the test was stopped.

From the above results, if there is no through hole as in Comparative Example 1, or if there is a thick skin layer formed of a rubber material in the proximity of through holes as in Comparative Example 1, it can be evaluated that the air permeability of the silicone sponge layer is not improved, and a change to the outer diameter was not controlled, and the durability decreases.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A silicone sponge roller for a fixing device, comprising:
a roller substrate; a silicone sponge layer formed on the outer periphery of the roller substrate; and a surface layer formed of a fluorocarbon resin formed on the outer periphery of the silicone sponge layer, wherein
the silicone sponge layer is a foam including a silicone rubber and a plurality of air bubble formed from microballoons scattered in the silicone rubber,
the silicone sponge layer includes a plurality of air permeating through holes aligned along the axis direction of the roller substrate, opening to both end surfaces of the silicone sponge layer, and
the air bubbles formed from the microballoons exist in the periphery of the through holes, and at least a part thereof is positioned in the inner surface of the through hole.

2. The silicone sponge roller for a fixing device of claim 1, wherein, in a cross-section of the silicone sponge layer perpendicularly cut with respect to the axis direction of the roller substrate, the total cross-section area of the through holes occupies 4.5% or more of the cross-section as compared to the cross-section area of the silicone sponge layer.

3. The silicone sponge roller for a fixing device of claim 1, wherein the silicone sponge roller for a fixing device exerts, when being installed in a decompression device to start decompression to reach −0.095 MPa, and ten minutes passes after a time when −0.095 is marked, a decompression expansion ratio which is 50% or less as compared to a case where a silicone sponge roller for a fixing device without a plurality of through holes is used.

4. The silicone sponge roller for a fixing device of claim 2, wherein the silicone sponge roller for a fixing device exerts, when being installed in a decompression device to start decompression to reach −0.095 MPa, and ten minutes passes after a time when −0.095 is marked, a decompression expansion ratio which is 50% or less as compared to a case where a silicone sponge roller for a fixing device without a plurality of through holes is used.

5. The silicone sponge roller for a fixing device of claim 1, wherein an open-cell ratio of the silicone sponge layer of the silicone sponge roller for a fixing device is 10% or less.

6. The silicone sponge roller for a fixing device of claim 2, wherein an open-cell ratio of the silicone sponge layer of the silicone sponge roller for a fixing device is 10% or less.

7. The silicone sponge roller for a fixing device of claim 3, wherein an open-cell ratio of the silicone sponge layer of the silicone sponge roller for a fixing device is 10% or less.

8. The silicone sponge roller for a fixing device of claim 4, wherein an open-cell ratio of the silicone sponge layer of the silicone sponge roller for a fixing device is 10% or less.

9. A heat fixing device including the silicone sponge roller for a fixing device of claim 1.

10. A heat fixing device including the silicone sponge roller for a fixing device of claim 2.

11. A heat fixing device including the silicone sponge roller for a fixing device of claim 3.

12. A heat fixing device including the silicone sponge roller for a fixing device of claim 4.

13. A heat fixing device including the silicone sponge roller for a fixing device of claim 5.

14. A heat fixing device including the silicone sponge roller for a fixing device of claim 6.

15. A heat fixing device including the silicone sponge roller for a fixing device of claim 7.

16. A heat fixing device including the silicone sponge roller for a fixing device of claim 8.
